(19) United States
(12) Patent Application Publication
(10) Pub. No.: US 2023/0115232 A1
(43) Pub. Date: Apr. 13, 2023

(54) REAR SUSPENSION SYSTEM FOR BICYCLES

(71) Applicant: Evan Turpen, Aptos, CA (US)

(72) Inventor: Evan Turpen, Aptos, CA (US)

(21) Appl. No.: 17/962,428

(22) Filed: Oct. 7, 2022

Related U.S. Application Data
(60) Provisional application No. 63/262,339, filed on Oct. 9, 2021.

(51) Int. Cl. B62K 25/28

(52) U.S. Cl. CPC B62K 25/286

(57) ABSTRACT

A rear suspension system for bicycles comprised of a bicycle main frame, upper link, lower link, swingarm, and rotatable idler member. The rear wheel follows a primarily rearwards and upwards axle path which is determined by the specific linkage geometry. The idler member is fixed to the bicycle main frame at one precise location. This idler member is positioned in such a way as to redirect drivetrain forces to create highly stable anti-squat characteristics at the statically loaded sag point in every gear combination.

This application claims the benefit of U.S. Provisional Application No. 63/262,339 filed Oct. 9, 2021.

### FIELD OF INVENTION

The invention relates to rear suspension systems for bicycles that provide highly stable anti-squat characteristics.

### BACKGROUND

Bicycles designed for off-road use regularly experience uneven and/or bumpy terrain. In order to maintain rider comfort and control suspension devices were added to these bicycles to help isolate the rider from the terrain. In general these suspension devices consist of a front shock absorbing device and a rear suspension system consisting of a single pivot point, multiple pivot points, sliding elements, linkages, or any combination of the above that control the movement of the rear wheel combined with a shock absorbing device.

With the advent of suspension systems for two-wheel vehicles, user comfort and control was increased. However, under powered acceleration (pedaling) this introduced the possibility of power loss through unwanted suspension movement. Using concepts proven from motorcycles and 4-wheeled vehicle suspension systems, bicycle designers learned to minimize these unwanted movements by specifically tuning the bicycle's anti-squat characteristics. Anti-squat is a suspension system's mechanical resistance to compression during powered acceleration as a result of its geometry.

Below 100% anti-squat there is unwanted compression of the suspension from pedaling. Above 100% anti-squat there can be unwanted extension of the suspension which lifts the bike and rider with every pedal stroke. At 100% anti-squat the suspension system is at equilibrium, the extension forces match the compression forces and the suspension will neither compress or extend from acceleration. 100% anti-squat response is widely believed to be ideal for efficiency, but in practice, anti-squat percentages above 100% can actually achieve a more stable acceleration response. This is because the anti-squat calculation does not (and can not) take into account the additional unpredictable vertical force that a rider applies during the oscillating motion of pedaling. Anti-squat percentages ranging from 105% up to 120% can achieve increased stability when compared to suspension systems outside this anti-squat percentage range.

When optimizing a suspension system for stable acceleration response it is also important to focus on the anti-squat percentages achieved in real-world sag positions. Sag is the amount a suspension system is compressed under the rider's weight in their normal riding position and is the area where the suspension system will encounter the most acceleration forces. Sag is described in percentage of total travel and is ideally between 25%-40% at the rear of the vehicle and 15%-25% at the front of the vehicle. These percentages can vary slightly due to rider setup preferences, type of riding, suspension design, body position and steepness of the pitch up or down. In a chain or belt-driven drivetrain system it is very difficult to achieve consistent anti-squat percentages in all gear combinations at the statically-loaded sag point in travel. This is due to the change in angle and position of the chain or belt's forces it exerts on the suspension system resulting from different gear combinations. In all currently available suspension designs, changing gear ratios directly affects the suspension system's anti-squat characteristics. In some suspension designs the change in anti-squat as a result of changing gear ratios can be drastic with some experiencing as much as a 300% change throughout the gear range. Skilled vehicle designers generally aim to achieve a stable anti-squat curve in certain gear combinations and points in travel while often sacrificing efficiency in other gear combinations and points in travel.

The present invention helps solve the problem of large changes in anti-squat as a result of changing gear ratios. The suspension system can achieve a desirable anti-squat percentage generally ranging from 100% all the way to 120% in every gear ratio at the statically loaded sag point in travel (where most acceleration occurs). The anti-squat can be easily tuned by manipulating the suspension system's linkage geometry. Furthermore, the variation in anti-squat percentages when outside of the ideal sag point is very minimal. This creates predictable and efficient acceleration response for more riders regardless of the exact sag point achieved by the end user. The suspension system accomplishes all of these goals by utilizing a specific rear suspension linkage orientation in combination with a specific rotatable idler member location to redirect drivetrain forces methodically.

### SUMMARY OF THE INVENTION

The suspension system is made up of a bicycle main frame, rear wheel swingarm, idler member, upper link, and lower link. The main frame typically, but not in all cases consists of: a head tube for mounting a front shock absorber, a seat tube, a down tube, a top tube, and a bottom bracket attachment of a pedal/drive apparatus, a connection to the top end of a spring/damper shock absorber, a connection to the upper link, a connection to the lower link, and a drive-side connection point for an idler member. The rear wheel swingarm consists of: a pair of dropouts to hold a rear wheel, a forward swingarm assembly to allow connection of the swingarm to the upper link and lower link, a pair of chainstays, one end connecting to the dropouts and the other to the forward swingarm assembly, a pair of seatstays, one end connecting to the dropouts and the other to the forward swingarm assembly. The upper link consists of two mounting points: connection to the bicycle main frame, and connection to the rear wheel swingarm. The lower link consists of three mounting points: connection to the bicycle main frame, connection to the rear wheel swingarm, and connection to the lower end of a spring/damper shock absorber.

The main frame and rear wheel swingarm allow for the attachment of conventional bicycle components such as a headset, seatpost, chain guide, drivetrain, wheels, and brakes in a standard configuration. The rear wheel swingarm has two attachment points: one for the upper link and one for the lower link. These attachment points are at specific locations that contribute to controlling the motion of the rear wheel and shock absorber.

The upper and lower links contribute to controlling the motion of the rear wheel and also contribute to controlling the ratio of the shock absorber compression in relation to the rear wheel compression. Under compression the upper link rotates counter-clockwise when viewed from the drive-side of the bike and the lower link rotates clockwise.

The specific main frame pivot locations, upper and lower link geometry, and rear wheel swingarm connections combine with the idler member placement to directly control anti-squat characteristics of the suspension system. Furthermore, the anti-squat is also independently tunable by changing the idler member size, position, or both.

### BRIEF DESCRIPTION OF THE DRAWINGS

FIG. 1 is a profile view of a preferred embodiment of the present invention illustrating all of the components that define the suspension system;

FIG. 2 is a profile view showing the method for graphically calculating anti-squat force in this type of suspension system; and

FIG. 3 is a graph of the anti-squat percentage vs vertical wheel travel percentage for the present invention in all gear combinations.

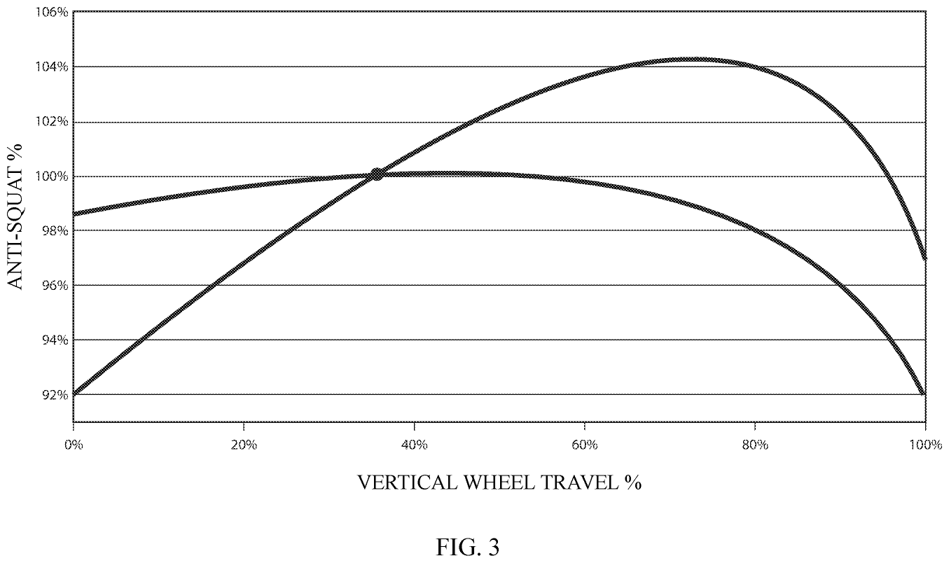

### DETAILED DESCRIPTION OF THE INVENTION

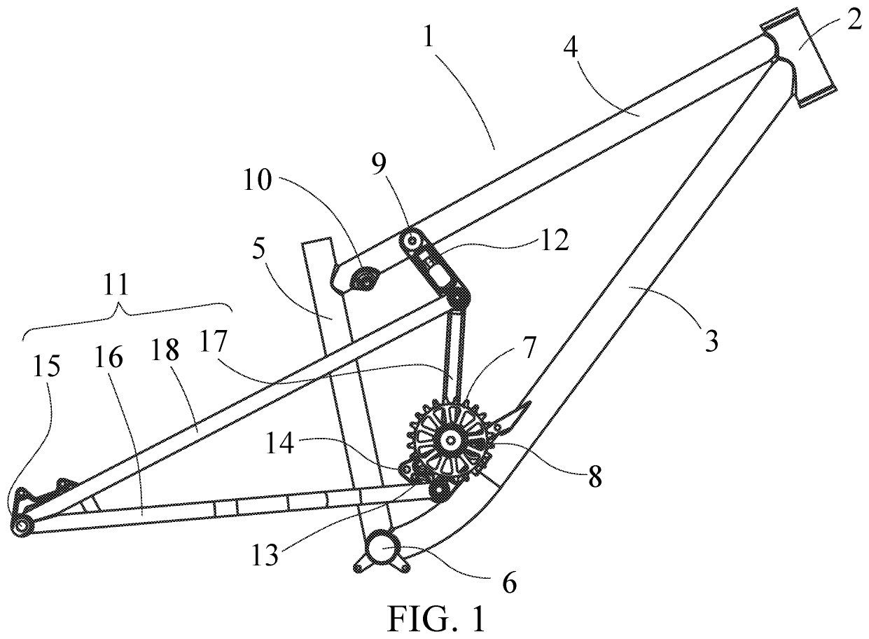

FIG. 1 depicts a preferred embodiment of a rear wheel suspension system of a bicycle of the present invention. The bicycle main frame 1 generally includes a head tube 2 attached to a down tube 3 and a top tube 4, a seat tube 5 attached to the top tube 4 and down tube 3, a bottom bracket 6 attached to the down tube 3 that houses a pedal/drive apparatus (not shown), a front fork mounted through the axis of the head tube 2 (not shown), and an idler member 7 attached to a down tube 3. In the preferred embodiment of the present invention there is a lower link pivot 8 located on the down tube 3 in front and above of the bottom bracket axis, an upper link pivot 9 located on the top tube 4 in front and above of the bottom bracket axis. Additionally, there is a connection near the top tube 4/seat tube 5 junction for the upper connection of a shock absorber 10 placed above and behind of the bottom bracket axis. These elements are typically welded, molded, or otherwise secured together to define the main frame 1 of the bicycle. Although the main frame 1 typically includes all of the foregoing members, alternative embodiments can have more or less of the foregoing members, and can include them in various forms, sizes, and configurations, and still achieve the intended functionality and beneficial aspects of the invention.

The rear wheel suspension system generally includes a rear wheel swingarm 11, an upper link 12, a lower link 13, an upper shock mount 10, a lower shock mount 14, and an idler member 7. The rear wheel swingarm 11 of the preferred embodiment includes a pivotal connection to the upper link 12 91.5 mm in front and 302.9 mm above the bottom bracket axis. The pivotal connections of the rear wheel suspension system are typically achieved through the use of bearings. The pivotal connection between the rear wheel swingarm 11 and the lower link 13 is located 69.4 mm in front and 70.8 mm above the bottom bracket axis. The pivotal connection between the upper link 12 and bicycle main frame 1 is located 37 mm in front and 371.7 mm above the bottom bracket axis. The pivotal connection between the lower link 13 and main frame 1 is located 112 mm in front and 123.7 mm above the bottom bracket axis. The main frame 1 includes a pivotal connection 10 near the top tube 4/seat tube 5 junction for the upper end of the shock absorber placed 17.6 mm behind and 320.3 mm above the bottom bracket axis. The lower link 13 includes a pivotal connection 14 for the lower end of the shock absorber placed 30.2 mm in front and 95.3 mm above the bottom bracket axis. The bicycle main frame 1 includes a connection for the rotatable idler member 7 placed 83.6 mm in front and 130.5 mm above the bottom bracket axis. It should be clear to one skilled in the art that a pivotal connection other than a bearing could be utilized for either pivotal connection. The pivotal connections could be contained within either the main frame 1, rear wheel swingarm 11, upper link 12 or lower link 13, and the distance between the pivotal connections in relation to the bottom bracket axis could be adjusted to accommodate various configurations without changing the scope of the present invention.

The rear wheel swingarm 11 includes a pair of rear wheel dropouts 15 joined to a pair of chain stays 16 at their rearward ends that are joined to a forward swingarm assembly 17 at their forward ends. The forward swingarm assembly 17 includes pivotal connections to the upper link 12 and lower link 13. The rear wheel dropout axis is placed 435 mm behind and 27 mm above the bottom bracket axis. The idler member 7 is 97.3 mm in diameter and has 24 teeth evenly spaced about its circumference with the correct tooth profile to engage positively with a bicycle chain.

The upper link 12 includes two pivotal connections: a pivotal connection to the bicycle main frame 1, and a pivotal connection to the rear wheel swingarm 11. The lower link includes three pivotal connections: a pivotal connection to the bicycle main frame 1, a pivotal connection to the rear wheel swingarm 11, and a pivotal connection to the lower end of the shock absorber 14. A shock absorber is pivotally engaged between the main frame upper shock mount 10 and lower shock mount 14 on the lower link 13. As the rear wheel is articulated generally upwards along its axle path, the shock absorber is compressed in length between the two mounting points providing resistance to the rear wheel's motion.

In addition to the above described members of the preferred embodiment, additional conventional elements such as those used to secure cables, brakes, drivetrain components and the like to the frame and keep them away from interfering with the movement and operation of the bicycle may also be attached at various locations. Persons of ordinary skill in the art will appreciate that the exact configuration and relationship between the chain stays 16, seat stays 18, rear wheel dropouts 15, forward swingarm assembly 17, main frame 1, upper link 12, lower link 13, idler member 7, and attachment points between all of these components can vary depending on, among other things, the size of the bicycle frame, and the size of the rear wheel. While a preferred embodiment in accordance with the present invention has been described and shown, it should be clear to those skilled in the art that further embodiments may be made without departing from the scope of the present invention.

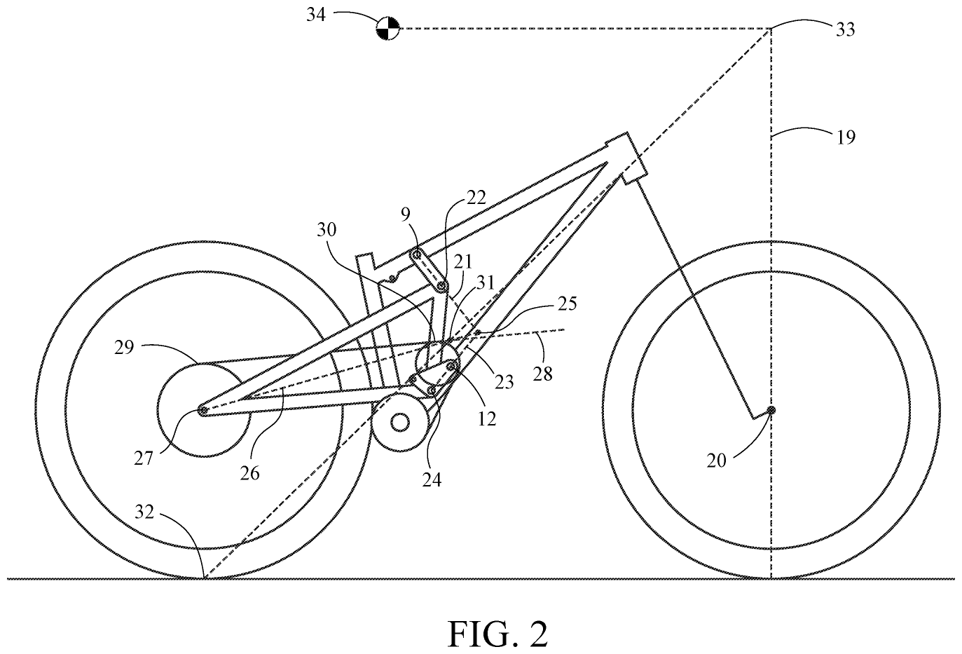

Referring to FIG. 2, the percent anti-squat can be calculated graphically by: drawing line 19 vertically through the front wheel axle 20, drawing line 21 by connecting the upper link to main frame pivot 9 through the upper link to rear wheel swingarm pivot 22, drawing line 23 by connecting the lower link to main frame pivot 12 through the lower link to rear wheel swingarm pivot 24, the intersection of lines 21 and 23 (represented as point 25) is the instantaneous force center, drawing line 26 by connecting the rear wheel dropout axis 27 with the instantaneous force center 25, drawing line 28 by connecting the top of rear cog 29 tangent to the top of idler member 30, the intersection point of lines 26 and 28 is the anti-squat instant center and is represented by point 31. To draw the anti-squat line, draw a line connecting the rear wheel's contact point with the ground 32 through point 31 and project it forwards to where it intersects line 19 (represented by point 33), this is the calculated anti-squat height measured vertically from the ground. The combined bike and rider center of gravity used in this anti-squat calculation is represented by point 34. Once the vertical height from the ground is known for points 33 and 34, the actual percentage of anti-squat is calculated by using the following equation (Anti-Squat height/Center of Gravity height)×100.

The center of gravity height is determined by taking the average center of gravity of two main riding positions (both bike and rider in a common seated pedaling position and standing position) for the average height and weight of rider for a given frame size.

It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A driven wheel suspension system for a two wheel vehicle comprising:
a chassis;
a rotatable idler member fixed to said chassis;
a rotatable crank mechanism fixed to said chassis for the transfer of power from a human pedaling;
a swingarm;
a driven wheel attached to said swingarm;
a looped power transmission element configured to transmit power from said crank mechanism to said driven wheel; wherein said looped power transmission element is redirected up and over said idler member and positively engages with said idler member on the upper power transmitting segment of the looped power transmission element;
an upper linkage member and a lower linkage member each with a first end pivotally connected to said chassis and a second end pivotally connected to said swingarm to control the movement of said swingarm with respect to said chassis; wherein all upper linkage member and lower linkage member pivotal connections are positioned entirely forwards of a vertical axis which extends from an axis of rotation of said crank mechanism; and wherein said upper linkage member and said lower linkage member rotate in opposite directions as the suspension moves;
an instant center defined as the intersection point of the force lines through both pivots of each of said linkage members; wherein said instant center position is in front of said lower linkage member pivotal connection to said chassis at full extension of the suspension and said instant center travels forwards as the suspension system is compressed;
a shock absorber with a first end pivotally connected to said chassis and a second end pivotally connected to said lower link; wherein said lower link acts as a lever arm to compress or extend said shock absorber and damp the motion of said swingarm in relation to said chassis during suspension movement.

2. The suspension system of claim 1, wherein said looped power transmission element is a chain.

3. The suspension system of claim 2, wherein said rotatable idler member is a sprocket.

4. The suspension system of claim 1, wherein said looped power transmission element is a belt.

5. The suspension system of claim 4, wherein said rotatable idler member is a pulley.

6. The suspension system of claim 1, wherein the power source is a human powered pedal and crank mechanism.

7. The suspension system of claim 1, wherein the power source is a human powered pedal and crank mechanism combined with an electric motor.

8. The suspension system of claim 1, wherein said rotatable idler member axis is fixed to said chassis within a 40 mm radius of said lower link pivotal connection axis to said chassis.

9. The suspension system of claim 6, wherein said shock absorber first end and second end are positioned entirely forwards of an axis which extends from a seat to an axis of rotation of said crank mechanism.

10. The suspension system of claim 7, wherein said shock absorber first end and second end are positioned entirely forwards of an axis which extends from a seat to an axis of rotation of said crank mechanism.

11. The suspension system of claim 1, wherein said upper linkage member has an axis from said first end pivot through said second end pivot thereof which extends in a forward and downward direction when said rear suspension is at full extension, and said lower linkage member has an axis from said first end pivot through said second end pivot which extends in a rearward and downward direction when said rear suspension is at full extension.
